(19) United States
(12) Patent Application Publication
(10) Pub. No.: US 2008/0269543 A1
(43) Pub. Date: Oct. 30, 2008

(54) Functional Device with a Detachable Component

(76) Inventor: Benny Rousso, Rishon LeZion (IL)

Correspondence Address: MOORE & VAN ALLEN PLLC, P.O. BOX 13706, Research Triangle Park, NC, 27709, US

(21) Appl. No.: 11/570,311

(22) PCT Filed: May 1, 2005
(86) PCT No.: PCT/IL05/00448

§ 371 Date: Dec. 8, 2006

(51) Int. Cl. A61M 1/10

(52) U.S. Cl. 600/16

(57) ABSTRACT

A device for enhancing blood circulation that includes a main element, a detachable element with an identification mark, and attachment means for grasping the detachable element by the main element. The main element functions by intermittently tightening and relaxing its grasp of the detachable element when activated. Additionally the main element authenticates the identification mark of the detachable element; and the main element is enabled to function if the authentication of the identification mark is positive.

### RELATED APPLICATIONS

The current application claims priority from PCT application serial No. PCT/IL2004/000487, filed on Jun. 9, 2004 and titled “A PORTABLE DEVICE FOR THE ENHANCEMENT OF CIRCULATION OF BLOOD AND LYMPH FLOW IN A LIMB”.

### FIELD OF THE INVENTION

The present invention relates to a functional device and in particular to a device that requires the attachment of a detachable component in order to function.

### BACKGROUND OF THE INVENTION

Many devices are known that comprise a main part and at least one detachable element that needs to be attached to the main part, or mounted thereon, in order for the device to function. The detachable element may be disposable and/or a consumable element, having a lifetime that is shorter than the lifetime of the device main part. Therefore, during the lifetime of the device it is anticipated that the detachable element will be replaced occasionally. Typically, the operation of the device depends on the compatibility between the main part and the detachable element. Thus, an element which does not completely match the device might hinder performance or prevent the device from functioning. In order to ensure performance of the device and prevent customer dissatisfaction a manufacturer is interested in assuring that a detachable element, which is manufactured by them or approved by them will be used.

In devices used for medical purposes, correct functionality of the device is especially important since it can affect the user's health. In PCT/IL2004/000487 filed by the applicant of the current application and incorporated herein by reference, there is described a medical device that is used to enhance blood circulation of a user. The device comprises an activation mechanism and a detachable strap for attaching to the user.

### SUMMARY OF THE INVENTION

An aspect of an embodiment of the invention, relates to a device for enhancing blood circulation that comprises a main element and a detachable element. Additionally, the device comprises an identification mechanism to assure that the detachable element comprises a specific identification, for example specific structure and/or markings to verify compatibility. In some embodiments of the invention, the device comprises an attachment mechanism to assure a predetermined positioning and verify attachment between the two elements.

In an exemplary embodiment of the invention, the detachable element is intended for a single user, for example for hygiene reasons, while the main element is transferable to other users. In some embodiments of the invention, the detachable element deteriorates and is recommended to be replaced every so often, for example periodically.

In an exemplary embodiment of the invention, the identification mechanism is based on a physical match between the two elements. Alternatively or additionally, the identification mechanism is based on optical recognition of a mark on the detachable element. Further alternatively or additionally, the identification mechanism is based on audio recognition of the detachable element.

In an exemplary embodiment of the invention, the mark on the detachable element comprises a specific pattern or word, for example the name of the device manufacturer or distributor. Optionally, the mark is recognized as a trademark of the device manufacturer or distributor.

In some embodiments of the invention, the attachment mechanism and identification mechanism are interdependent. For example the attachment mechanism will not succeed if the identification mechanism fails or the identification mechanism will not succeed if the attachment mechanism fails.

In an exemplary embodiment of the invention, the device will not function if either of the above mechanisms fails.

There is thus provided according to an exemplary embodiment of the invention, a device for enhancing blood circulation, including a main element, a detachable element with an identification mark, attachment means for grasping the detachable element by the main element, wherein the main element functions by intermittently tightening and relaxing its grasp of the detachable element when activated, wherein the main element authenticates the identification mark of the detachable element; and wherein the main element is enabled to function if the authentication of the identification mark is positive.

In an exemplary embodiment of the invention, the device includes an attachment verification mechanism, which verifies an attachment between the main element and the detachable element. Optionally, the attachment verification mechanism is able to verify attachment only if the authentication of the identification mark is positive.

In an exemplary embodiment of the invention, the authentication is possible only if the attachment verification mechanism is able to verify an attachment between the main element and the detachable element. Optionally, the main element can function only if the attachment verification between the main element and the detachable element is successful.

In an exemplary embodiment of the invention, the authentication comprises determining a physical match between the mark and a predetermined mark. Optionally, the authentication comprises determining a match between the mark and a predetermined mark by image matching.

In an exemplary embodiment of the invention, the authentication comprises authenticating a light signal. Optionally, the authentication comprises authenticating an infrared signal.

In an exemplary embodiment of the invention, the authentication comprises authenticating an audio signal. Optionally, the authentication comprises authenticating an ultrasonic signal.

In an exemplary embodiment of the invention, the authentication comprises authenticating by more than one method of authentication. Optionally, the authentication is performed when attaching the detachable element.

In an exemplary embodiment of the invention, the authentication is performed when activating the main element. Optionally, the authentication is performed continuously.

In an exemplary embodiment of the invention, the detachable element comprises a sleeve. Optionally, the detachable element is adapted to be deployed on a user's skin.

In an exemplary embodiment of the invention, the detachable element is adapted to be deployed over a user's clothes. Optionally, the main element is adapted to be deployed on a user's skin.

In an exemplary embodiment of the invention, the main element is adapted to be deployed over a user's clothes. Optionally, the mark comprises alphanumeric letters.

In an exemplary embodiment of the invention, the mark does not comprise alphanumeric letters. Optionally, the mark comprises alphanumeric letters and non alphanumeric letters.

In an exemplary embodiment of the invention, the mark comprises a trademark. Optionally, the detachable element transmits a signal to said main element.

In an exemplary embodiment of the invention, the detachable element draws power from the main element. Optionally, the device comprises a wireless transmitter to activate said main element.

Additionally, there is provided according to an exemplary embodiment of the invention, a device, comprising a main element with an authentication mechanism, a detachable element with an identification mark, an attachment verification mechanism, wherein the attachment verification mechanism verifies attachment between the main element and the detachable element if the authentication mechanism positively authenticates the identification mark.

Additionally, there is provided according to an exemplary embodiment of the invention, a device, comprising a main element with an authentication mechanism, a detachable element with an identification mark, an attachment verification mechanism, wherein the authentication mechanism authenticates the identification mark if the attachment verification mechanism verifies an attachment between the main element and the detachable element.

### BRIEF DESCRIPTION OF THE DRAWINGS

The present invention will be understood and appreciated more fully from the following detailed description taken in conjunction with the drawings in which:

FIG. 1 is a schematic illustration of a device for enhancing circulation deployed on a user according to an exemplary embodiment of the invention.

FIG. 2A is a schematic illustration of a device for enhancing circulation according to an exemplary embodiment of the invention.

FIG. 2B is a schematic illustration of an alternative detachable element for a device for enhancing circulation according to an exemplary embodiment of the invention.

FIG. 3A is a schematic illustration of a device for enhancing circulation with a physical matching authentication mechanism, according to an exemplary embodiment of the invention.

FIG. 3B is a schematic illustration of the detachable element for the device in FIG. 3A, according to an exemplary embodiment of the invention.

FIG. 3C is a schematic illustration of the device in FIG. 3A with the detachable element deployed, according to an exemplary embodiment of the invention.

FIG. 4A is a schematic illustration of a side view of a device for enhancing circulation with an image matching authentication mechanism, according to an exemplary embodiment of the invention.

FIG. 4B is a schematic illustration of a frontal view of the device in FIG. 4A, according to an exemplary embodiment of the invention.

FIG. 5A is a schematic illustration of a rear view of a device for enhancing circulation with a physical matching and image matching authentication mechanism, according to an exemplary embodiment of the invention.

FIG. 5B is a schematic illustration of a rear view of the device of FIG. 5A in a locked position, according to an exemplary embodiment of the invention.

FIG. 6A is a schematic illustration of a device for enhancing circulation with an infrared authentication mechanism, according to an exemplary embodiment of the invention.

FIG. 6B is a schematic illustration of the device in FIG. 6A in a locked position, according to an exemplary embodiment of the invention.

FIG. 7 is a schematic illustration of a device for enhancing circulation with an audio authentication mechanism, according to an exemplary embodiment of the invention.

FIG. 8 is a schematic illustration of a device for enhancing circulation with an external activation mechanism, according to an exemplary embodiment of the invention.

### DETAILED DESCRIPTION

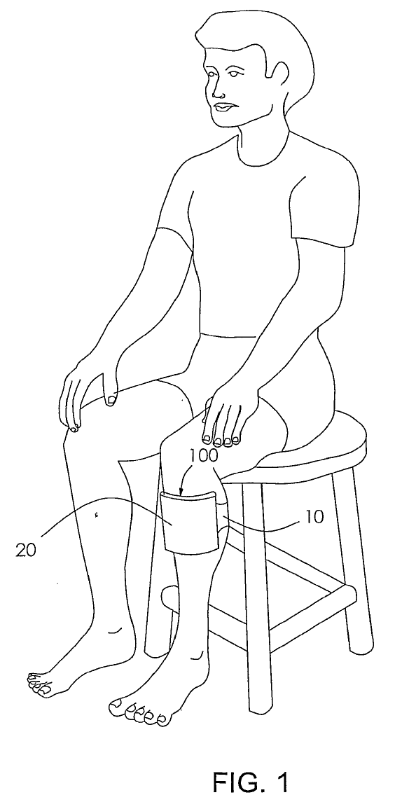

FIG. 1 is a schematic illustration of a device 100 for enhancing circulation deployed on a user according to an exemplary embodiment of the invention. In an exemplary embodiment of the invention, device 100 is positioned over a muscle of a user, for example over the calf as shown in FIG. 1 or other muscles. Optionally, device 100 intermittently compresses the muscle to enhance blood and lymph flow in the enclosed user limb. Generally blood flow enhancement is considered helpful for the user's health, for example to prevent Deep Vein Thrombosis (DVT), reduce lymph edema and other health problems.

As shown in FIG. 1 device 100 comprises a main element 20 which comprises the machinery needed to activate device 100 and a detachable element 10 which grasps a user's limb. In an exemplary embodiment of the invention, device 100 can be worn on a bare limb or over a user's clothes. Optionally, in use detachable element 10 is attached to main element 20 and main element 20 tightens and relaxes its grip on detachable element 10 intermittently, causing it to press and release the user's muscle, thus increasing blood and lymph flow in the blood vessels of the user's limb.

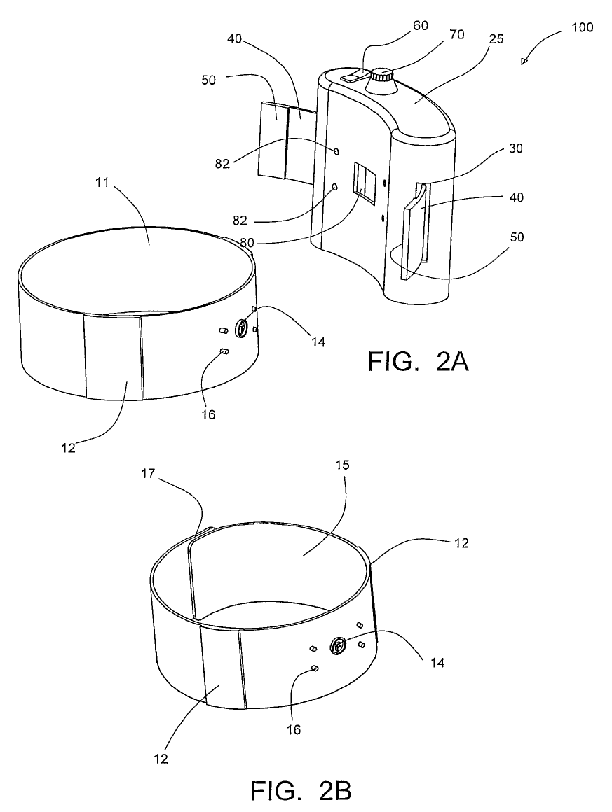

FIG. 2A is a schematic illustration of a device 100 for enhancing circulation according to an exemplary embodiment of the invention. In an exemplary embodiment of the invention, detachable element 10 is provided in the form of a sleeve 11 which fits over the user's limb, at least partially embracing the user's muscle. Optionally sleeve 11 is provided from a flexible material that is stretched over the user's limb. Alternatively, sleeve 11 may be provided in various sizes to fit different size users.

In some embodiments of the invention, sleeve 11 is fabricated from a material that is non-irritating to the user's skin. In some embodiments of the invention, sleeve 11 is positioned over the user's clothes or over a protective bandage and sleeve 11 is not brought into contact with the user's skin. In some embodiments of the invention, sleeve 11 may be fabricated from more than one type of material, for example part of it may be elastic and part may be non-elastic. In some embodiments of the invention, sleeve 11 is provided from material that deteriorates over time and/or as a result of its use. Optionally, sleeve 11 is replaced after every use or after a certain number of uses.

In some embodiments of the invention, sleeve 11 comprises an attachment area 12 which is provided for attaching main element 20 to sleeve 11, for example using hook and loop fastener material, for example Velcro. Optionally, attachment area 12 is part of sleeve 11 or attached on the exterior of sleeve 11, for example by sewing a piece of Velcro onto sleeve 11.

In some embodiments of the invention, other fastening means are used for example snaps, a zipper, buttons, string, hooks, magnets or other materials and/or methods. [any other possible means?]

In an exemplary embodiment of the invention, main element 20 comprises an encasement 25, with a slit 30 on both sides of encasement 25. Optionally, an internal mechanism for pulling and releasing is provided inside encasement 25 with straps 40 attached to the mechanism and exiting encasement 25 through slits 30. In an exemplary embodiment of the invention, straps 40 comprise an attachment area 50, for example with Velcro to match attachment area 12 on sleeve 11. However as noted above other attachment means may be used. Optionally, the internal mechanism pulls and releases straps 40 causing sleeve 11 to tighten and relax its grip on the user's muscles. In some embodiments of the invention, both sides of main element 20 pull and release straps 40. Alternatively, only one side of the internal mechanism pulls on straps 40. Optionally, one of straps 40 may be attached in a fixed position to encasement 25, without need for a slit 30 on that side. An internal mechanism such as mentioned above is described and illustrated in the PCT application filed by the applicants and referenced above.

In some embodiments of the invention, main element 20 comprises an activation switch 60 for turning the device on and off. In some embodiments of the invention, main element 20 comprises a selection dial 70 for selecting the rate and/or force at which the device will operate.

In an exemplary embodiment of the invention, sleeve 11 is provided with an identification mark 14 to authenticate that sleeve 11 is original. Optionally, main element 20 has a matching receptor 80 for detecting identification mark 14, for example an image detector (e.g. CCD). In an exemplary embodiment of the invention, a user is required to position main element 20 so that receptor 80 is facing identification mark 14.

In some embodiments of the invention, identification mark 14 comprises only alphanumeric letters. Alternatively, identification mark 14 comprises only an image without letters. In some embodiments of the invention, identification mark 14 comprises images and letters. Optionally, identification mark 14 comprises a specific word or a specific name, for example the name of the manufacturer of device 100.

In an exemplary embodiment of the invention, main element 20 prevents activating the device if receptor 80 does not confirm authentication of identification mark 14. In an exemplary embodiment of the invention, identification mark 14 may be a connector, for example a snap or a mechanical protrusion, which allows activation of main element 20 only when it is deployed to match receptor 80. In some embodiments of the invention, multiple marks 14 and receptors 80 are used.

Optionally, mark 14 and receptor 80 may be supported by a plurality of different elements that ensure a specific positioning, for example sleeve 11 may comprise one or more snaps 16 or hook and loop fastener material (e.g. Velcro) or other means, surrounding mark 14. Accordingly main element 20 is supplied with sockets 82 for snaps 16 to ensure a specific positioning.

FIG. 2B is a schematic illustration of an alternative detachable element for device 100 according to an exemplary embodiment of the invention. In an exemplary embodiment of the invention, detachable element 10 comprises a strap 15, which is wrapped around the user's muscle instead of a sleeve 11, which is pulled over the user's muscle. In some embodiments of the invention, users may find strap 15 easier to use than sleeve 11 since it is wrapped on based on the size of the user's muscle or limb. Additionally, strap 15 does not require removal of a user's shoe and can be used by a user with a cast or other interferences at the end of the user's limb. Alternatively, users may find sleeve 11 easier to use since it does not require closing and opening and there is less chance of accidental release.

Optionally, strap 15 comprises attachments at the ends 17 such as described above in order to form a closed contour around the user's muscle as provided by sleeve 11. Optionally, strap 15 comprises attachment areas 12, marks 14 and snaps 16 as described regarding sleeve 11.

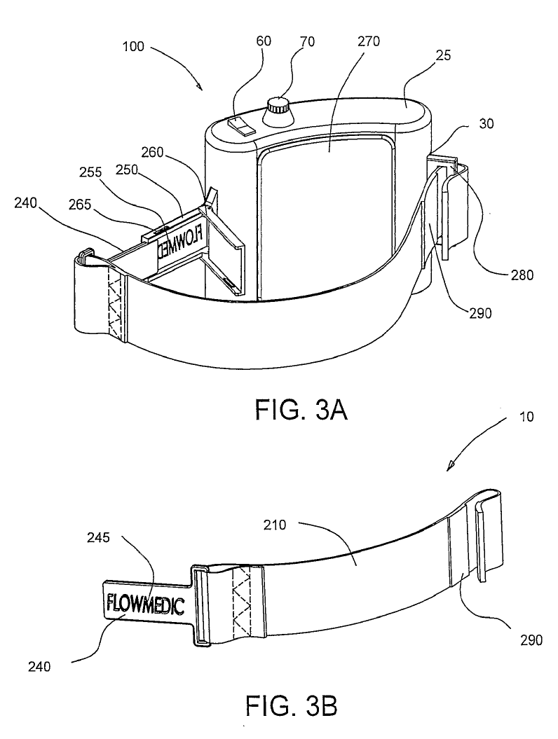

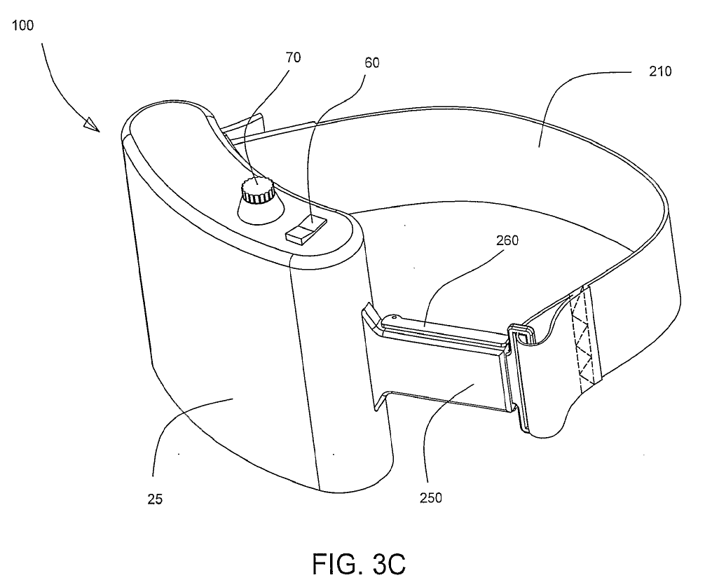

FIG. 3A is a schematic illustration of device 100 for enhancing circulation with a physical matching authentication mechanism, according to an exemplary embodiment of the invention. In an exemplary embodiment of the invention, device 100 comprises main element 20 and detachable element 10, which is provided in this embodiment as a strap 210. Optionally, strap 210 comprises a buckle 240, which is used for authentication and/or positioning of strap 210 relative to main element 20.

FIG. 3B is a schematic illustration of detachable element—strap 210 for the device in FIG. 3A, according to an exemplary embodiment of the invention.

FIG. 3C is a schematic illustration of the device in FIG. 3A with detachable element 210 deployed, according to an exemplary embodiment of the invention.

In an exemplary embodiment of the invention, main element 20 comprises an internal mechanism which moves a rod ending with a handle 280, in and out through slit 30 of encasement 25. Optionally, an end of strap 210 is inserted into handle 280 and folded over in order for strap 210 to grasp handle 280. Optionally, matching fastening means 290 are positioned at two locations near the end of strap 210 in order to secure the grasp of the strap on handle 280. In an exemplary embodiment of the invention, fastening means 290 may be hook and loop fastener material, snaps, buttons or other means as described above. In an exemplary embodiment of the invention, the other end of strap 210 is connected to buckle 240. Optionally, the end of strap 210 that is connected to buckle 240 is folded over and permanently fastened together, for example by sewing, stapling or gluing so that buckle 240 cannot be readily removed from strap 210. In some embodiments of the invention, buckle 240 comprises a mark 245 (e.g. an inscription) which protrudes from the surface of buckle 240 and serves to identify the strap to main element 220. In an exemplary embodiment of the invention, main element 220 comprises a compartment 250 with a cover 260 for locking over buckle 240. In an exemplary embodiment of the invention, buckle 240 is inserted into compartment 250. Optionally, compartment 250 has an impression, which matches mark 245. In an exemplary embodiment of the invention, cover 260 for compartment 250 can only be closed as shown in FIG. 3C when mark 245 matches impression 255, thus authenticating strap 210 and its attachment position. In some embodiments of the invention, cover 260 comprises a protrusion which fits into crevice 265 on compartment 250 in order to prevent cover 260 from unintentionally opening up.

In FIG. 3A compartment 250 is external to encasement 25, however it should be noted that compartment 250 may be internal to encasement 25 or partially internal and partially external. In some embodiments of the invention, compartment 250 is formed like a socket (such as commonly used for seat belts). Optionally, buckle 240 will lock into the socket only if mark 245 matches impression 255.

In some embodiments of the invention, a protective pad 270 is attached to encasement 25 to provide cushioning in deploying device 100 on a user's limb. In some embodiments of the invention, protective pad 270 is disposable and replaced on every use or after a few uses.

In some embodiment of the invention, compartment 250 is moveable like handle 280 so that both sides of device 100 are moved during use.

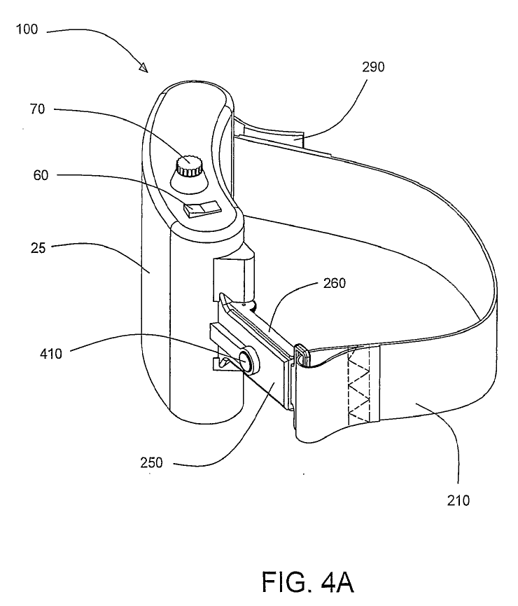

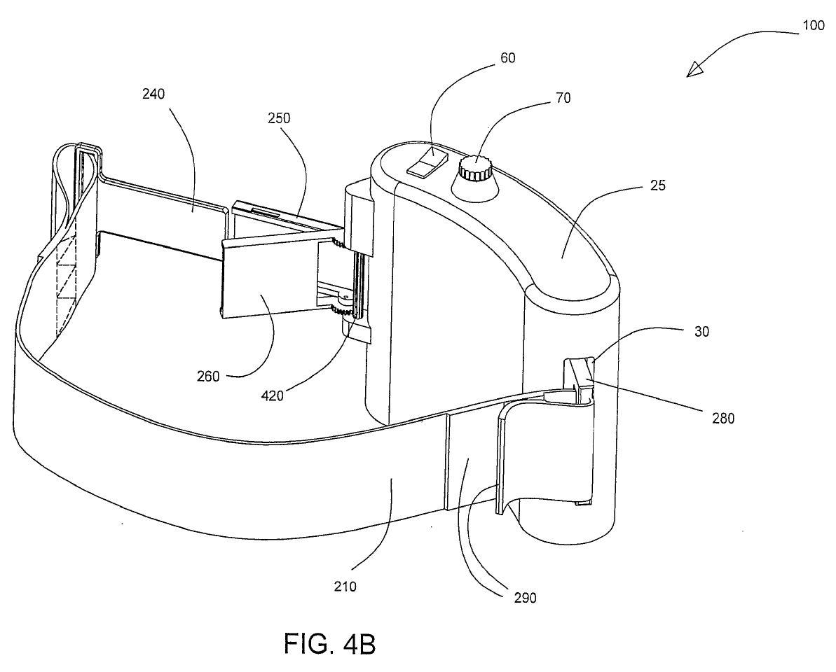

FIG. 4A is a schematic illustration of a side view of device 100 for enhancing circulation with an image matching authentication mechanism, according to an exemplary embodiment of the invention.

FIG. 4B is a schematic illustration of a frontal view of the device 100 as shown in FIG. 4A, according to an exemplary embodiment of the invention.

In an exemplary embodiment of the invention, device 100 comprises an image detection device 410 for example a CCD. Optionally, inscription 245 is sampled by image detection device 410. In an exemplary embodiment of the invention, device 100 compares the sampled image with a pattern stored in a memory in device 100. In some embodiments of the invention, device 100 verifies a match between the entire sampled image and the stored pattern. Alternatively, device 100 only verifies a preselected part of the sampled image, for example a part that is recognized as a symbol of the manufacturer (e.g. a trademark).

In an exemplary embodiment of the invention, cover 260 is controlled by an automatic mechanism 420. Optionally, after insertion of buckle 240 into compartment 250 device 100 determines if strap 210 is a genuine one by sampling the image. If device 100 determines that strap 210 is genuine (i.e. positive determination) it instructs automatic mechanism 420 to close cover 260. Optionally, device 100 begins operation only if cover 260 is closed. In some embodiments of the invention, insertion of buckle 240 powers on device 100 to begin determination as described above. Alternatively, switch 60 is used to power on device 100.

In an exemplary embodiment of the invention, device 100 is turned off by opening cover 260. Alternatively, device 100 is powered off by switch 60, regardless of the status of cover 260.

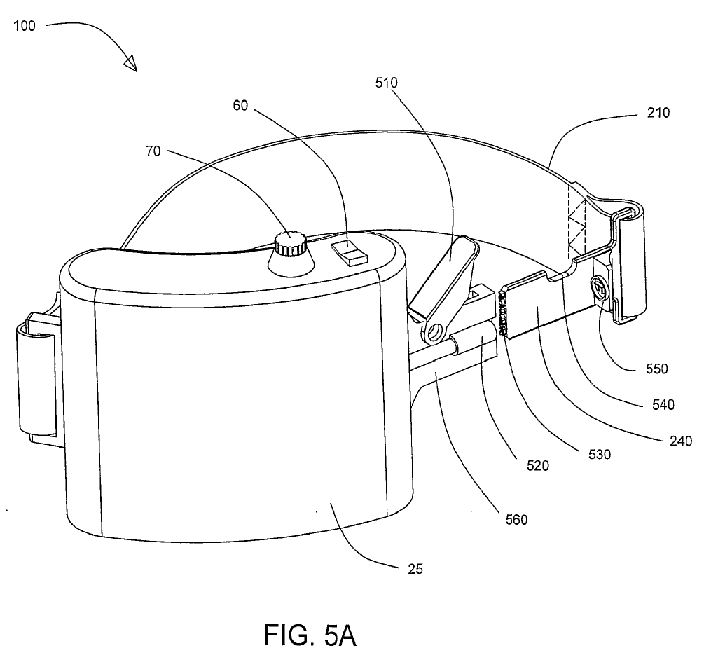

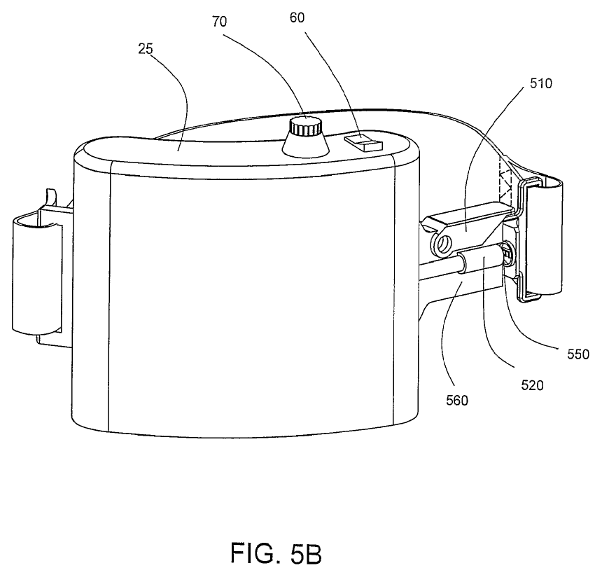

FIG. 5A is a schematic illustration of a rear view of device 100 for enhancing circulation with a physical matching and image matching authentication mechanism, according to an exemplary embodiment of the invention.

In an exemplary embodiment of the invention, more than one method of authenticating that detachable element 10 is genuine is used simultaneously, for example as shown in FIGS. 5A and 5B. In an exemplary embodiment of the invention, buckle 240 comprises an embossment 530 at its fore end. Embossment 530 is prepared to match a socket in compartment 560 in order to permit full insertion of buckle 240 into compartment 560. if the embossment does not match the socket in compartment 560, buckle 240 will bulge out and will not be able to be secured in place. In some embodiments of the invention, when buckle 240 is fully inserted a clasp 510 is lowered over buckle 240 and locks it in place. Optionally, buckle 240 has a crevice 540, which is grasped by clasp 510, in order to lock buckle 240 in place. FIG. 5B is a schematic illustration of device 100 of FIG. 5A in a locked position, according to an exemplary embodiment of the invention.

In an exemplary embodiment of the invention, buckle 240 comprises an additional identification to hinder duplication and prevent errors in authentication. In an exemplary embodiment of the invention, buckle 240 comprises a pattern 550, which can be the same or different than embossment 530. Optionally, an imaging device 520 (e.g. a CCD) scans pattern 550 and compares it to a pattern stored in the memory of device 100. Optionally, only if imaging device 520 returns a positive result and buckle 240 fits into compartment 560 will device 100 function. In some embodiments of the invention, more than two authentications can be performed simultaneously. Optionally, the device will function if all or at least a majority of the authentication devices give confirmation.

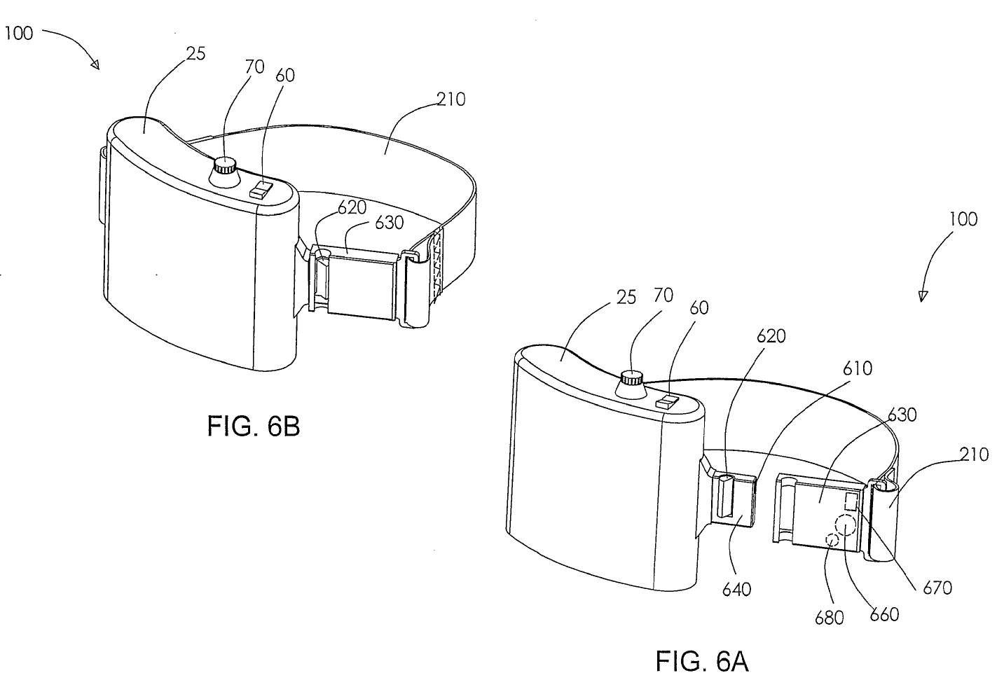

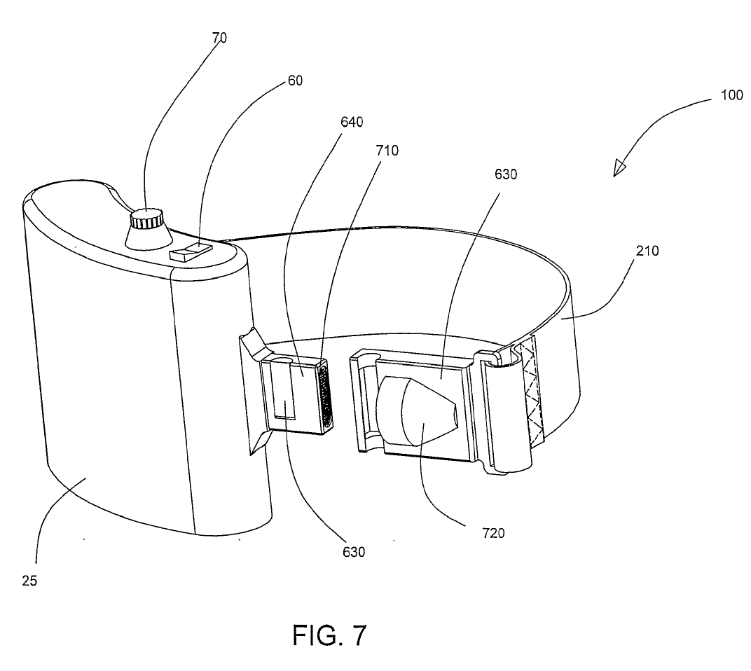

FIG. 6A is a schematic illustration of device 100 with an infrared detector, according to an exemplary embodiment of the invention. In an exemplary embodiment of the invention, device 100 comprises a protruding attachment element 640. Optionally strap 210 is attached to a hollow encasement 630, which fits over attachment element 640. In an exemplary embodiment of the invention, attachment element 640 comprises an infrared detector 610 to receive a signal from removable element 10, in order to authenticate that the device is genuine. In some embodiments of the invention, hollow encasement 630 comprises an infrared transmitter 670 that supplies a signal to infrared detector 610 to authenticate that a genuine removable element 10 is deployed. Optionally, hollow encasement 630 comprises a battery 660 that supplies power to infrared transmitter 670. In some embodiments of the invention, hollow encasement 630 forms electrical contact with attachment element 640 to enable transfer of electric power from device 100 to power infrared transmitter 670. Optionally, infrared transmitter 670 is activated when hollow encasement 630 is deployed and power is supplied.

In some embodiments of the invention, infrared transmitter 670 is activated by a switch 680, for example a pressure activated switch, which is activated when attachment element 640 is deployed into hollow encasement 630. Alternatively, switch 680 is user controllable and activated by an instruction from the user to authenticate detachable element 10.

In some embodiments of the invention, a single authentication signal is sufficient for authenticating detachable element 10. Alternatively, detachable element 10 is authenticated continuously while deployed.

In some embodiments of the invention, protruding attachment element 640 additionally comprises a locking mechanism 620 to lock hollow encasement 630 over attachment element 640. In an exemplary embodiment of the invention, locking mechanism 620 comprises a rotatable column. Optionally, in a first position the rotatable column enables hollow encasement 630 to be inserted and removed from covering attachment element 640. Upon rotating the rotatable column, for example 90° or 180°, hollow encasement 630 is locked in place so that it cannot move relative to attachment element 640. in some embodiments of the invention, device 100 is functional only when hollow encasement 630 is locked in place as described above.

FIG. 6B is a schematic illustration of the device in FIG. 6A in a locked position, according to an exemplary embodiment of the invention.

FIG. 7 is a schematic illustration of device 100 for enhancing circulation with an audio authentication mechanism, according to an exemplary embodiment of the invention. In an exemplary embodiment of the invention, device 100 authenticates detachable element 10 with an audio activation mechanism. Optionally, attachment element 640 comprises a microphone 710 to detect an audio signal for authenticating detachable element 10. In an exemplary embodiment of the invention, hollow encasement 630 comprises a speaker 720 that produces audio signals to be detected by microphone 710. In some embodiments of the invention, speaker 720 transmits audible audio signals, alternatively or additionally, speaker 720 transmits non audible audio signals (e.g. ultrasonic signals).

In some embodiments of the invention, speaker 720 functions analogously to infrared transmitter 670. As described above, speaker 720 may draw power from a battery or from device 100. Additionally, speaker 720 may authenticate detachable element 10 with a single audio transmission or with a continuous transmission.

In some embodiments of the invention, pattern 550 shown in FIG. 5A may be a light source, for example a diode. Optionally, the light source functions analogously to infrared transmitter 670. As described above, the light source may draw power from a battery or from device 100. Additionally, the light source may authenticate detachable element 10 by a single light flash or with an intermittent flash of light or by a continuous light.

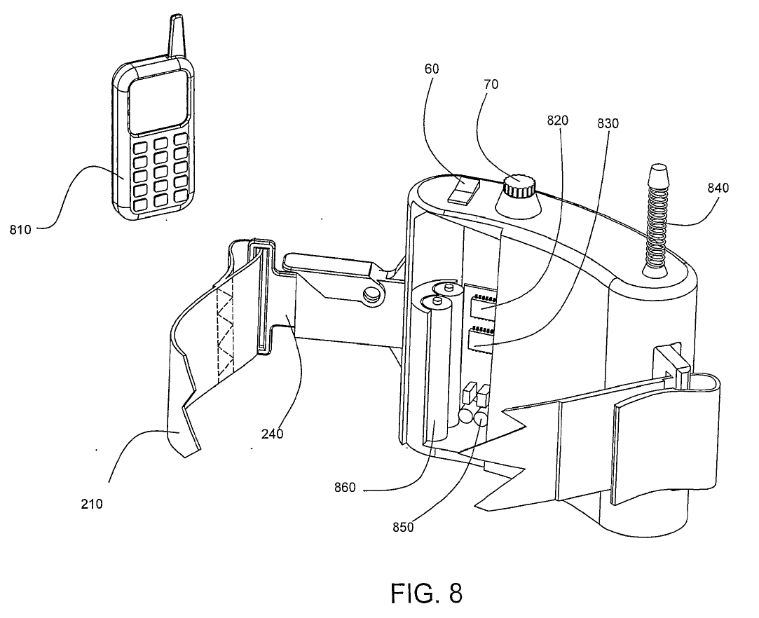

FIG. 8 is a schematic illustration of device 100 for enhancing circulation with an external activation mechanism, according to an exemplary embodiment of the invention.

In some embodiments of the invention, device 100 is activated by a wireless activator 810, for example by an RF transmitter, a mobile telephone, a blue tooth transmitter, an audio transmitter, an infrared transmitter or other known wireless transmitters. Optionally, device 100 comprises a wireless receiver 840 (e.g. antenna, microphone) to receive wireless transmissions. Optionally, use of wireless activator 810 enables a user to activate and/or deactivate device 100 without bending over, looking at or touching the device. In some embodiments of the invention, a person can control device 100 remotely for a user or for multiple users. FIG. 8 additionally shows optional internal elements of device 100. In some embodiment of the invention, device 100 comprises a power source 860, for example batteries. In some embodiments of the invention, device 100 comprises an electronic circuit 850 for dealing with controlling device 100 and performing functions as described above. As known in the art an electronic circuit such as electronic circuit 850 is able, for example to deal with reception of signals, analysis of signals, analysis of sampled images, analysis of sounds, logic decisions (e.g. activation, deactivation) and any other actions which need to be controlled. Optionally, electronic circuit 850 comprises a processor 820 and a memory 830 in order to carry out the above functions. In an exemplary embodiment of the invention, memory 830 comprises a non-volatile memory with representations of images, sounds and signals for comparison with received values.

It should be noted that the relative sizes of elements shown in the figures are for illustration purposes only and some elements may be smaller or larger than actually shown.

It should be appreciated that the above described methods and devices may be varied in many ways, including omitting or adding steps, changing order of the steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention. Section headings are provided for assistance in navigation and should not be considered as necessarily limiting the contents of the section.

It will be appreciated by persons skilled in the art that the present invention is not limited to what has been particularly shown and described hereinabove. Rather the scope of the present invention is defined only by the claims which follow.

1. A device for enhancing blood circulation, comprising:
a main element;
a detachable element with an identification mark;
attachment means for grasping said detachable element by said main element;
wherein said main element functions by intermittently tightening and relaxing its grasp of said detachable element when activated;
wherein said main element authenticates the identification mark of said detachable element; and
wherein said main element is enabled to function if said authentication of said identification mark is positive.

2. A device according to claim 1, comprising an attachment verification mechanism, which verifies all attachment between said main element and said detachable element

3. A device according to claim 2, wherein said attachment verification mechanism is able to verify attachment only if said authentication of said identification mark is positive.

4. A device according to claim 2, wherein said authentication is possible only if attachment verification mechanism is able to verify an attachment between said main element and said detachable element.

5. A device according to claim 1, wherein said main element can function only if attachment verification between said main element and said detachable element is successful.

6. A device according to claim 1, wherein said authentication comprises determining a physical match between said mark and a predetermined mark.

7. A device according to claim 1, wherein said authentication comprises determining a match between said mark and a predetermined mark by image matching.

8. A device according to claim 1, wherein said authentication comprises authenticating a light signal.

9. A device according to claim 8, wherein said authentication comprises authenticating an infrared signal.

10. A device according to claim 1, wherein said authentication comprises authenticating an audio signal.

11. A device according to claim 10, wherein said authentication comprises authenticating an ultrasonic signal.

12. A device according to claim 1, wherein said authentication comprises authenticating by more than one method of authentication.

13. A device according to claim 1, wherein said authentication is performed when attaching said detachable element.

14. A device according to claim 1, wherein said authentication is performed when activating said main element.

15. A device according to claim 1, wherein said authentication is performed continuously.

16. A device according to claim 1, wherein said detachable element comprises a sleeve.

17. A device according to claim 16, wherein said detachable element is adapted to be deployed on a user's skin.

18. A device according to claim 16, wherein said detachable element is adapted to be deployed over a user's clothes.

19. A device according to claim 1, wherein said main element is adapted to be deployed on a user's skin.

20. A device according to claim 1, wherein said main element is adapted to be deployed over a user's clothes.

21. A device according to claim 1, wherein said mark comprises alphanumeric letters.

22. A device according to claim 1, wherein said mark does not comprise alphanumeric letters.

23. A device according to claim 1, wherein said mark comprises alphanumeric letters and non alphanumeric letters.

24. A device according to claim 1, wherein said mark comprises a trademark.

25. A device according to claim 1, wherein said detachable element transmits a signal to said main element.

26. A device according to claim 1, wherein said detachable element draws power from said main element.

27. A device according to claim 1, comprising a wireless transmitter to activate said main element.

28. A device, comprising:
a main element with an authentication mechanism;
a detachable element with an identification mark;
an attachment verification mechanism;
wherein said attachment verification mechanism verifies attachment between said main element and said detachable element if said authentication mechanism positively authenticates said identification mark.

29. A device, comprising:
a main element with an authentication mechanism;
a detachable element with an identification mark;
an attachment verification mechanism;
wherein said authentication mechanism authenticates said identification mark if said attachment verification mechanism verifies an attachment between said main element and said detachable element.
